(19) United States
(12) Patent Application Publication
(10) Pub. No.: US 2025/0368380 A1
(43) Pub. Date: Dec. 4, 2025

(54) CELLULOSIC STRUCTURES, CELLULOSIC CONTAINERS, AND METHODS FOR MANUFACTURING THEREOF

(71) Applicant: WestRock MWV, LLC, Atlanta, GA (US)

(72) Inventors: Rahul BHARDWAJ, Glen Allen, VA (US); Mackenzie A. COSGRO, Richmond, VA (US); JOEL C. PANEK, Moseley, VA (US); Justin L. BENNETT, Williamsburg, VA (US); Meredith W. ALLIN, Richmond, VA (US)

(21) Appl. No.: 18/877,908

(22) PCT Filed: Mar. 24, 2023
(86) PCT No.: PCT/US2023/064933

§ 371 Date: Dec. 20, 2024

Related U.S. Application Data
(60) Provisional application No. 63/353,746, filed on Jun. 20, 2022.

(51) Int. Cl. B65D 3/22; B31B 50/26; B31B 100/00; B31B 110/20; B32B 1/00; B32B 27/10; B32B 27/30; B65D 3/04; B65D 3/14

(52) U.S. Cl. CPC B65D 3/22; B31B 50/26; B32B 1/00; B32B 27/10; B32B 27/306; B65D 3/04; B65D 3/14; B31B 2100/00; B31B 2110/20; B32B 2255/10; B32B 2255/20; B32B 2307/31; B32B 2307/718; B32B 2307/7244; B32B 2439/02

(57) ABSTRACT

A cellulosic structure includes a cellulosic board substrate having a first side and a second side and an outermost heat seal layer on the first side of the cellulosic board substrate. An oxygen barrier resin layer and a metal oxide coated polymer barrier film are between the first side of the cellulosic board substrate and the outermost heat seal layer.

### PRIORITY

This application claims priority from U.S. Ser. No. 63/353,746 filed on Jun. 20, 2022, the entire contents of which are incorporated herein by reference.

### FIELD

The present application relates to the field of high barrier cellulosic structures for cellulosic containers.

### BACKGROUND

Paper-based containers typically are formed from a blank, such as blank of paperboard. The paperboard blank is die cut to the desired silhouette and then the blank is formed into the desired container shape. For example, the blank may be wrapped around a mandrel to form a cylindrical or frustoconical container body. A bottom component is typically connected to the container body to enclose the lower end of the container body. After filling the container, a lid component is typically connected to the container body to fully enclose the container. The contents of paper-based containers may be exposed to oxygen, moisture and/or light which penetrates through the walls of such containers. Depending on the contents of the container, oxygen, moisture and/or light penetration may result in product degradation. For example, foodstuffs may degrade much more quickly and, thus, may have a significantly shorter shelf life when packaged in containers that do not significantly exclude oxygen, moisture and light.

Thus, paper-based containers have been formed from material having barrier properties. For example, conventional paper-based containers typically have metallic barrier layers incorporated into paperboard blanks used to form containers for foodstuffs sensitive to degradation due to oxygen, moisture and light penetration. However, incorporation of the metallic barrier layers limits the recyclability of the paper-based containers.

There is a need for a new recyclable material that still has the same or similar barrier properties as these conventional paper-based containers that incorporate metallic barrier layers.

Accordingly, those skilled in the art continue with research and development in the field of cellulosic structures for cellulosic containers and methods for manufacturing thereof

### SUMMARY

Disclosed are cellulosic structures.

In one example, the disclosed cellulosic structure includes a cellulosic board substrate having a first side and a second side and an outermost heat seal layer on the first side of the cellulosic board substrate. An oxygen barrier resin layer and a metal oxide coated polymer barrier film are between the first side of the cellulosic board substrate and the outermost heat seal layer.

Also disclosed are cellulosic containers.

In one example, the disclosed cellulosic container includes a sidewall component, a bottom component enclosing the first end of the sidewall component, and a lid component enclosing the second end of the sidewall component. The sidewall component has a first end and a second end. The sidewall component includes a cellulosic board substrate having a first side and a second side, an outermost heat seal layer on the first side of the cellulosic board substrate; an oxygen barrier resin layer between the first side of the cellulosic board substrate and the outermost heat seal layer, and a metal oxide coated polymer barrier film between the first side of the cellulosic board substrate and the outermost heat seal layer.

Also disclosed are methods for manufacturing a cellulosic structure.

In one example, the disclosed method for manufacturing a cellulosic structure includes (1) extruding an oxygen barrier resin layer onto a first side of a cellulosic board substrate; (2) positioning a metal oxide coated polymer barrier film on the extruded oxygen barrier resin layer; and (3) applying a heat seal layer on the metal oxide coated polymer barrier film.

In another example, the disclosed method for manufacturing a cellulosic structure includes (1) coating a liquid adhesive oxygen barrier resin layer onto a first side of a cellulosic board substrate; (2) positioning a metal oxide coated polymer barrier film on the liquid adhesive oxygen barrier resin layer; and (3) applying a heat seal layer on the metal oxide coated polymer barrier film.

Other examples of the disclosed cellulosic structures, cellulosic containers, and methods for manufacturing thereof will become apparent from the following detailed description, the accompanying drawings and the appended claims.

### BRIEF DESCRIPTION OF THE DRAWINGS

FIG. 1 is an illustration of a representation of a cellulosic structure according to one example of the present description.

FIG. 2 is an illustration of a sidewall component of a cellulosic container according to one example of the present description.

FIG. 3 is an illustration of a cellulosic container according to one example of the present description.

### DETAILED DESCRIPTION

Goals of the present description include developing a recyclable material that has the same or similar barrier properties as metallic barrier layers by applying an ultra-high barrier film on cellulosic board substrates.

Metal oxide coated polymer barrier films can be laminated to cellulosic board substrates to achieve ultra-high barrier properties to oxygen and moisture. However, when such a laminate is folded to 90- or 180-degrees, there is a decrease in barrier performance, particularly an increase of oxygen and moisture vapor transmission rate. The oxygen barrier property is damaged more severely than the moisture barrier property. In the approach of the present description, it was identified that when an oxygen barrier resin layer is used as a tie-layer to laminate the metal oxide coated film, the oxygen barrier performance was significantly improved even after folding the laminate to 90- and 180-degrees. Such folding of a laminate is expected in package conversion so barrier integrity after folding is critical.

The disclosed cellulosic structure of the present description includes a cellulosic board substrate having a first side and a second side, an outermost heat seal layer on the first side of the cellulosic board substrate, and an oxygen barrier resin layer and a metal oxide coated polymer barrier film between the outermost heat seal layer and the first side of the cellulosic board substrate. The oxygen barrier resin layer may be positioned between the first side of the cellulosic board substrate and the metal oxide coated polymer barrier film, or the metal oxide coated polymer barrier film may be positioned between the first side of the cellulosic board substrate and the oxygen barrier resin layer. The presence of the oxygen barrier resin layer inhibits (e.g., diminishes or avoids) oxygen barrier degradation of the cellulosic board substrate upon folding of the cellulosic board substrate. Additional layers may be included in the disclosed cellulosic structure without departing from the scope of the present disclosure.

In an aspect, the second side of the cellulosic board substrate is free of a heat sealable layer. In another aspect, the second side of the cellulosic board substrate is free of polyolefin. In another aspect, the second side of the cellulosic board substrate is polymer free. In another aspect, the second side of the cellulosic board substrate is uncoated.

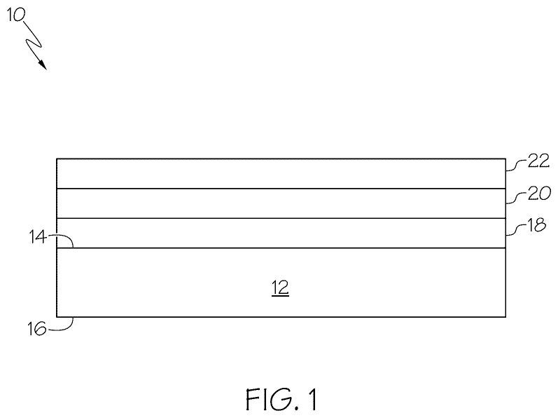

Referring to FIG. 1, one illustrated example of the disclosed cellulosic structure 10 of the present description includes a cellulosic board substrate 12 having a first side 14 and a second side 16, an oxygen barrier resin layer 18 on the first side 14 of the cellulosic board substrate 12, a metal oxide coated polymer barrier film 20 on the oxygen barrier resin layer 18, and an outermost heat seal layer 22 on the metal oxide coated polymer barrier film 20. In one alternative example, the positions of the oxygen barrier resin layer 18 and the metal oxide coated polymer barrier film 20 may be reversed, in which case a tie layer is preferably disposed between the metal oxide coated polymer barrier film 20 and the first side 14 of the cellulosic board substrate 12. Further examples including additional layers between the outermost heat seal layer 22 and the first side 14 of the cellulosic board substrate 12 are included in the present description.

The cellulosic board substrate 12 of the present description is not limited and may include any cellulosic board substrate 12 formed of a cellulosic material. In an exemplary aspect, the cellulosic board substrate 12 may include or be a paperboard substrate, particular a single layer paperboard substrate.

In some examples, the cellulosic board substrate 12 may be characterized as having a maximum transmittance (% T). However, disclosed cellulosic structure of the present description is not limited to a cellulosic board substrate 12 having a defined maximum transmittance (% T). In an aspect, the cellulosic board substrate 12 may have a maximum transmittance (% T) in a range of 300-700 nm of 4.0% or less, such as 3.0% or less, 2.0% or less, 1.0% or less, 0.5% or less, or 0.3% or less. The maximum transmittance is tested at 23 degrees Celsius. Thus, the cellulosic board substrate having low maximum transmittance contributes to resistance against light penetration into a container formed therefrom that may result in product degradation. The maximum transmittance of the cellulosic board substrate may result from a combination of factors, including lignin content of the cellulosic board substrate, caliper thickness of the cellulosic board substrate, and basis weight of the cellulosic board substrate. By reducing the maximum transmittance of the cellulosic board substrate, the cellulosic board substrate of the present application may eliminate or reduce the requirement for other means for resisting against light penetration.

In an aspect, the cellulosic board substrate 12 may have a lignin content of 2% or more, by weight, such as 4% or more, 6% or more, 8% or more, 10% or more, 12% or more, 14% or more, 16% or more, or 18% or more. The lignin content of the cellulosic board substrate contributes to resistance against light penetration into a container formed therefrom that may result in product degradation. The lignin may act as chromophore which functions as a light barrier. By increasing the lignin content of the cellulosic board substrate, the maximum transmittance of the cellulosic board substrate is reduced.

In an aspect, the cellulosic board substrate 12 may have a basis weight in a range of 180 to 300 pounds per 3000 ft², such as 210 to 260 pounds per 3000 ft². In an example, a 20 pt. board may be used having a basis weight of 240 pounds per 3000 ft². The basis weight of the cellulosic board substrate contributes to resistance against light penetration into a container formed therefrom that may result in product degradation. By increasing the basis weight of the cellulosic board substrate, the maximum transmittance of the cellulosic board substrate is reduced. In other aspects, the basis weight of the of the cellulosic board substrate may be less than 180 pounds per 3000 ft² or greater than 290 pounds per 3000 ft².

In an aspect, the cellulosic board substrate 12 may have a caliper thickness in a range of 10 to 36 points, such as 14 to 30 points or 18 to 22 points. The caliper thickness of the cellulosic board substrate contributes to resistance against light penetration into a container formed therefrom that may result in product degradation. By increasing the caliper thickness of the cellulosic board substrate, the maximum transmittance of the cellulosic board substrate is reduced. In other aspects, the caliper thickness of the cellulosic board substrate may be less than 14 points or greater than 30 points. The caliper thickness of the cellulosic board substrate may depend on various factors, such as the density of the cellulosic board substrate. As used herein, 1 point equals 0.001 inches, which equals 25.4 micrometers (μm).

The oxygen barrier resin layer 18 functions as a barrier layer to oxygen. The oxygen barrier resin layer 18 may include or be an oxygen barrier polymer that is extruded or coated onto the cellulosic board substrate 12. Examples of suitable oxygen barrier polymer are polyvinyl alcohols (PVOH) and ethylene vinyl alcohols (EVOH). Another example of a suitable oxygen barrier polymer is nylon. In yet another example, the oxygen barrier resin layer 18 may be (or may include) thermoplastic starch.

In an exemplary aspect, the oxygen barrier resin layer 18 may be melt extruded at high temperature to connect the metal oxide coated polymer barrier film 20 to the cellulosic board substrate 12 without necessitating an additional tie layer between the oxygen barrier resin layer 18 and the metal oxide coated polymer barrier film 20. In an another exemplary aspect, the oxygen barrier resin layer 18 may have two (or more) positions: (1) between the metal oxide coated polymer barrier film 20 and the cellulosic board substrate 12 and (2) also on the opposite/reverse side of the metal oxide coated polymer barrier film 20. In an exemplary aspect, the oxygen barrier resin layer 18 may be an aqueous adhesive that is coated onto the cellulosic board substrate 12 to adhere the metal oxide coated polymer barrier film 20 to the cellulosic board substrate 12 without necessitating an additional tie layer between the oxygen barrier resin layer 18 and the metal oxide coated polymer barrier film 20. In yet another exemplary aspect, the oxygen barrier resin layer 18 may be disposed onto the cellulosic board substrate 12 is any form and the metal oxide coated polymer barrier film 20 may be laminated to the cellulosic board substrate 12 using a tie layer or in any other suitable manner. Alternatively, the positions of the oxygen barrier resin layer 18 and the metal oxide coated polymer barrier film 20 may be reversed, in which case a tie layer may be disposed between the metal oxide coated polymer barrier film 20 and the first side 14 of the cellulosic board substrate 12. In the case of a tie layer, the tie layer may include any suitable tie layer. For example, the tie layer may include or be polyolefin, such as low density polyethylene. The tie layer may be melt extruded at high temperature. In another aspect, the tie layer may include or be, for example, an aqueous adhesive.

The metal oxide coated polymer barrier film 20 is polymer film having a metal oxide coating thereof. The metal oxide coated polymer barrier film 20 functions as a barrier layer to oxygen and moisture. The metal oxide coated polymer barrier film 20 may include or be, for example, an aluminum oxide coated polymer barrier film. As another specific example, the metal oxide coated polymer barrier film 20 may include or be a silicon oxide coated polymer barrier film. The polymer of the metal oxide coated polymer barrier film 20 is not limited. In an aspect, the polymer of the metal oxide coated polymer barrier film 20 may include or be a polyester or polyolefin. In another aspect, the polymer of the metal oxide coated polymer barrier film 20 may include or be polyethylene terephthalate. The presence of the metal oxide coated polymer barrier film 20 facilitates the resistance to the passage of oxygen and moisture to the interior of a container formed from the cellulosic structure 10. However, the metal oxide coated polymer barrier film 20 may be transparent and not prevent the passage of light. Therefore, in the case of a cellulosic board substrate 12 having a defined maximum transmittance (% T), the combination of the cellulosic board substrate 12 having a defined maximum transmittance (% T) and the metal oxide coated polymer barrier film 20 can provide for resistance to the passage of oxygen, moisture, and light to the interior of a container formed from the cellulosic structure 10.

The disclosed metal oxide coated polymer barrier film 20 is formed as a metal oxide coated polymer barrier film 20 before formation of the cellulosic structure 10 of the present description. The disclosed metal oxide coated polymer barrier film 20 may be formed by coating a polymer (e.g., polyethylene terephthalate) film with the metal oxide. The metal oxide coated polymer barrier film 20 may be selected from commercially available metal oxide coated polymer barrier film 20 from a variety of sources.

The outermost heat seal layer 22 may include or be, for example, low density polyethylene. In another aspect, the outermost heat seal layer 22 may include or be, for example from a family of polyolefins homopolymer, co-polymers, terpolymers, and their functionalized and modified forms. In another aspect, the outermost heat seal layer 22 may include or be ethylene methyl acrylate (EMA). In other expressions, the outermost heat seal layer 22 may be formed from other materials capable of being activated, such as with heat, ultrasonic energy, radiation or the like, to form a seal. Combinations of sealing materials may be used to form the heat seal layer 22. In specific examples, the heat seal layer 22 may include monolayer or co-extruded structures.

In an aspect, the cellulosic structure 10 has a maximum transmittance (% T) in a range of 300-700 nm of 1.0% or less, such as 0.5% or less, 0.3% or less, 0.2% or less, 0.1% or less, or 0.05% or less. The maximum transmittance of the cellulosic structure may be controlled by decreasing the maximum transmittance of the cellulosic board substrate or by other means for resisting against light penetration. By reducing the maximum transmittance of the cellulosic structure 10 a content of a container formed therefrom may be protected from degradation due to light. By reducing the maximum transmittance of the cellulosic structure 10, the present description can eliminate the use of metal foil or pigments such as carbon black, thus providing for a recyclable high barrier cellulosic structure for forming cellulosic containers.

In another aspect, the cellulosic structure 10 may have an oxygen transmission rate of less than 0.1 cc/m2/day at 1 atm. In another aspect, the cellulosic structure 10 may have a moisture vapor transmission rate of less than 0.1 g/m2/day.

In another aspect, the cellulosic structure 10 may have at least 80%, by weight, cellulosic content, such as has at least 85%, by weight, cellulosic content, or at least 90%, by weight, cellulosic content. A remainder of the cellulosic structure may include or be the tie layer, the metal oxide coated polymer, and the heat seal layer, or additional coating layers.

In an aspect, the cellulosic structure 10 may be formed by an extrusion lamination process. In the extrusion lamination process, the oxygen barrier resin layer 18 may be used as a tie layer to bond the metal oxide coated polymer barrier film 20 to the first side 14 of the cellulosic board substrate 12. Thus, the oxygen barrier resin layer 18 may be extruded onto the first side 14 of the cellulosic board substrate 12 and the metal oxide coated polymer barrier film 20 may be positioned on the extruded oxygen barrier resin layer 18 and then the extruded oxygen barrier resin layer 18 is cooled to bond the metal oxide coated polymer barrier film 20 to the first side 14 of the cellulosic board substrate 12.

Alternatively, an additional tie layer may be used to bond the metal oxide coated polymer barrier film 20 to the first side 14 of the cellulosic board substrate 12. Thus, the additional tie layer may be extruded onto the first side 14 of the cellulosic board substrate 12 and the metal oxide coated polymer barrier film 20 may be positioned on the extruded tie layer and then the extruded tie layer is cooled to bond the metal oxide coated polymer barrier film 20 to the first side 14 of the cellulosic board substrate 12. In an aspect, the oxygen barrier resin layer 18 may be positioned between the first side 14 of the cellulosic board substrate 12 and the extruded tie layer. In an aspect, the oxygen barrier resin layer 18 may be positioned between the metal oxide coated polymer barrier film 20 and the outermost heat seal layer 22.

In an aspect, the cellulosic structure 10 may be formed by adhesive coating process. In the adhesive coating process, the oxygen barrier resin layer 18 may be used as a tie layer to bond the metal oxide coated polymer barrier film 20 to the first side 14 of the cellulosic board substrate 12. Thus, the oxygen barrier resin layer 18 may be coated as a liquid adhesive onto the first side 14 of the cellulosic board substrate 12 and the metal oxide coated polymer barrier film 20 may be positioned on the oxygen barrier resin layer 18 coating and then the oxygen barrier resin layer 18 coating is dried to bond the metal oxide coated polymer barrier film 20 to the first side 14 of the cellulosic board substrate 12.

Alternatively, an additional tie layer may be used to bond the metal oxide coated polymer barrier film 20 to the first side 14 of the cellulosic board substrate 12. Thus, the additional tie layer may be coated as a liquid adhesive onto the first side 14 of the cellulosic board substrate 12 and the metal oxide coated polymer barrier film 20 may be positioned on the coated tie layer and then the coated tie layer is dried to bond the metal oxide coated polymer barrier film 20 to the first side 14 of the cellulosic board substrate 12. In an aspect, the oxygen barrier resin layer 18 may be positioned between the first side 14 of the cellulosic board substrate 12 and the extruded tie layer. In an aspect, the oxygen barrier resin layer 18 may be positioned between the metal oxide coated polymer barrier film 20 and the outermost heat seal layer 22.

The coated cellulosic structure preferably has a maximum transmittance and can be used to form containers for foodstuffs sensitive to degradation due to oxygen, moisture and light penetration. The coated cellulosic structure maintains a sufficient oxygen barrier despite folding/bending of the substrate. Even when the substrate is folded or bent, degradation of the oxygen barrier is inhibited (e.g., diminished or avoided) at the folded or bent areas. The structural integrity of the oxygen barrier is maintained at areas of folding or bending of the substrate (or at least maintained at a level sufficient to perform effectively as an oxygen barrier). For conventional techniques and paper-based substrates that use metal oxide coated films, such as AlOx coated PET, as an oxygen barrier, cracks or breakpoints are formed in that layer/barrier along or adjacent to fold lines. For the coated cellulosic structure of the present description, degradation of the oxygen barrier as a result of the formation of such cracks/breaks along or adjacent to fold lines is inhibited (e.g., diminished or avoided).

In an aspect, the cellulosic structure 10 has an oxygen transmission rate of less than 1.0 cc/m2/day at 1 atm after folding to 90 degrees, when tested at 23° C. and 50 percent relative humidity. In another aspect, the cellulosic structure 10 has an oxygen transmission rate of less than 0.5 cc/m2/day at 1 atm after folding to 90 degrees, when tested at 23° C. and 50 percent relative humidity. In another aspect, the cellulosic structure 10 has an oxygen transmission rate of less than 0.1 cc/m2/day at 1 atm after folding to 90 degrees, when tested at 23° C. and 50 percent relative humidity.

In an aspect, the cellulosic structure 10 has an oxygen transmission rate of less than 1.0 cc/m2/day at 1 atm after folding to 180 degrees, when tested at 23° C. and 50 percent relative humidity. In another aspect, the cellulosic structure 10 has an oxygen transmission rate of less than 0.5 cc/m2/day at 1 atm after folding to 180 degrees, when tested at 23° C. and 50 percent relative humidity. In yet another aspect, the cellulosic structure 10 has an oxygen transmission rate of less than 0.1 cc/m2/day at 1 atm after folding to 180 degrees, when tested at 23° C. and 50 percent relative humidity.

In an aspect, the cellulosic structure 10 has a moisture vapor transmission rate of less than 1.0 g/m2/day after folding to 90 degrees, when tested at 23° C. and 50 percent relative humidity. In another aspect, the cellulosic structure 10 has a moisture vapor transmission rate of less than 0.5 g/m2/day after folding to 90 degrees, when tested at 23° C. and 50 percent relative humidity. In yet another aspect, the cellulosic structure 10 has a moisture vapor transmission rate of less than 0.1 g/m2/day after folding to 90 degrees, when tested at 23° C. and 50 percent relative humidity.

In an aspect, the cellulosic structure 10 has a moisture vapor transmission rate of less than 1.0 g/m2/day after folding to 180 degrees, when tested at 23° C. and 50 percent relative humidity. In another aspect, the cellulosic structure 10 has a moisture vapor transmission rate of less than 0.5 g/m2/day after folding to 180 degrees, when tested at 23° C. and 50 percent relative humidity. In another aspect, the cellulosic structure 10 has a moisture vapor transmission rate of less than 0.1 g/m2/day after folding to 180 degrees, when tested at 23° C. and 50 percent relative humidity.

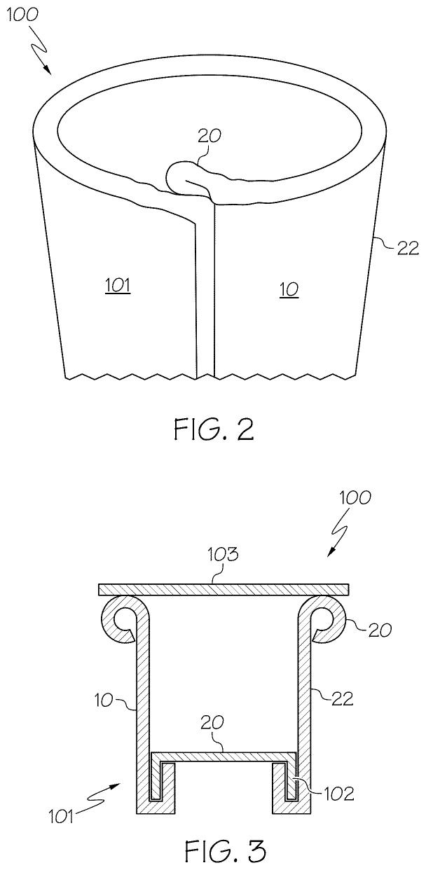

Referring to FIGS. 2 and 3, also disclosed is a container 100 formed from the cellulosic structure 10. In one expression, the container 100 includes a sidewall component 101 having a first end and a second end, a bottom component 102 enclosing the first end of the sidewall component, and a lid component 103 enclosing the second end of the sidewall component. The sidewall component includes a cellulosic board substrate 12 having a first side 14 and a second side 16, an oxygen barrier resin layer 18 on the first side 14 of the cellulosic board substrate 12, a metal oxide coated polymer barrier film 20 on the oxygen barrier resin layer 18, and an outermost heat seal layer 22 on the metal oxide coated polymer barrier film 20. The positions of the oxygen barrier resin layer 18 and the metal oxide coated polymer barrier film 20 may be reversed, in which case a tie layer is preferably disposed between the metal oxide coated polymer barrier film 20 and the first side 14 of the cellulosic board substrate 12. Further examples including additional layers between the outermost heat seal layer 22 and the first side 14 of the cellulosic board substrate 12 are included in the present description.

The sidewall component 101 may be formed by, for example, die-cutting a sheet of the disclosed cellulosic structure 10 (FIG. 1) to form a sidewall blank having the desired silhouette (e.g., trapezoidal or rectangular). Then, the sidewall blank is formed into the desired sidewall component shape. In the illustrated example, the sidewall blank is bent by 90 degrees. In an alternative container example, the sidewall blank may be bent by 180 degrees. The outermost heat seal layer 22 may be activated to seal together the sidewall component 101. The bottom component 102 is typically connected to the sidewall component 101 to enclose the lower end of the sidewall component 101. After filling the container, the lid component 103 is typically connected to the sidewall component 101 to fully enclose the container. The outermost heat seal layer 22 may be activated to seal together the sidewall component 101, the bottom component 102, and the lid component 103. The bottom component 102 or the lid component 103 may be formed from the disclosed cellulosic structure 10 or may be formed from a different material.

### Experimental Examples

In a control example, a 20 pt. CustomKote LS board was laminated with AlOx coated PET barrier film using LDPE tie-layer. CustomKote is a coated natural kraft (CNK) board. The resulting laminated board has a structure: paperboard/LDPE/AlOx coated PET/Heat Seal Layer, it has average oxygen transmission rate (OTR) of 0.06 cc/m\hat{ }2·day at 23 C/50% RH but when folded to 90- and 180-degree angle, the average oxygen transmission rate become 1.6 and 2.4 cc/m\hat{ }2·day at 23 C/50% RH, so there is a deterioration in oxygen barrier performance and there was a 40-fold increase in OTR after 180 degree fold. The average moisture vapor transmission rate (MVTR) of such board was 0.12 g/m\hat{ }2·day at 23 C/75% RH which become 0.2 and 0.3 g/m\hat{ }2·day at 23 C/75% RH after 90 and 180 degree folds.

In a second example, a 20 pt. CustomKote LS board was laminated with AlOx coated PET barrier film using water based PVOH adhesive. Such board has a structure: paperboard/adh·PVOH/AlOx coated PET. Such board without folding has an average OTR of 0.01 cc/m\hat{ }2·day at 23 C/50% RH but when folded to 90- and 180-degree angles, the average oxygen transmission rate become 0.07 and 0.11 cc/m\hat{ }2·day at 23 C/50% RH. There was 11-fold increase in the average OTR after 180-degree folding, so barrier performance significantly improved as compared to the control example. The MVTR performance of this structure was 0.2 and 0.3 g/m\hat{ }2·day at 23 C/75% RH after 90- and 180-degree folding, similar to the control example.

In a third example, when same AlOx coated PET barrier film was laminated to board using extruded PVOH, oxygen barrier also found to improve as compared to the control in folded samples. Such board has a structure; 16 pt. SBS board/ext. PVOH/AlOx PET, this structure has an average OTR of 0.03 and 0.08 cc/m\hat{ }2·day at 23 C/50% RH after 90- and 180-degree folds, which validates the benefit of using PVOH as a tie-layer which provides supplemental oxygen barrier as well. The MVTR performance of this structure was 0.5 g/m\hat{ }2·day at 23 C/75% RH after both 90- and 180-degree folds.

In a fourth example, the MVTR performance after 180-degree folding of the above structure was improved after adding a heat seal layer. The new structure was 16 pt. SBS board/ext. PVOH/AlOx PET/heat seal layer. Such heat seal layer comprised of Low-Density Polyethylene (LDPE). The MVTR performance of this structure was 0.1 g/m\hat{ }2·day at 23 C/75% RH after 180-degree folding. This example demonstrates that both balance of OTR and MVTR could be achieved with this new inventive step.

Further, the disclosure comprises examples according to the following clauses:

Clause 1. A cellulosic structure, comprising: a cellulosic board substrate having a first side and a second side; an outermost heat seal layer on the first side of the cellulosic board substrate; an oxygen barrier resin layer between the first side of the cellulosic board substrate and the outermost heat seal layer; and a metal oxide coated polymer barrier film between the first side of the cellulosic board substrate and the outermost heat seal layer.

Clause 2. The cellulosic structure of Clause 1, wherein the cellulosic board substrate has a maximum transmittance (% T) in a range of 300-700 nm of 4.0% or less.

Clause 3. The cellulosic structure of Clause 1, wherein the cellulosic board substrate has a maximum transmittance (% T) in a range of 300-700 nm of 3.0% or less.

Clause 4. The cellulosic structure of Clause 1, wherein the cellulosic board substrate has a maximum transmittance (% T) in a range of 300-700 nm of 2.0% or less.

Clause 5. The cellulosic structure of Clause 1, wherein the cellulosic board substrate has a maximum transmittance (% T) in a range of 300-700 nm of 1.0% or less.

Clause 6. The cellulosic structure of Clause 1, wherein the cellulosic board substrate has a maximum transmittance (% T) in a range of 300-700 nm of 0.5% or less.

Clause 7. The cellulosic structure of Clause 1, wherein the cellulosic board substrate has a maximum transmittance (% T) in a range of 300-700 nm of 0.3% or less.

Clause 8. The cellulosic structure of any preceding clause, wherein the cellulosic board substrate has a lignin content of 2% or more, by weight.

Clause 9. The cellulosic structure of any preceding clause, wherein the cellulosic board substrate has a lignin content of 4% or more, by weight.

Clause 10. The cellulosic structure of any preceding clause, wherein the cellulosic board substrate has a lignin content of 6% or more, by weight.

Clause 11. The cellulosic structure of any preceding clause, wherein the cellulosic board substrate has a lignin content of 8% or more, by weight.

Clause 12. The cellulosic structure of any preceding clause, wherein the cellulosic board substrate has a lignin content of 10% or more, by weight.

Clause 13. The cellulosic structure of any preceding clause, wherein the cellulosic board substrate has a lignin content of 12% or more, by weight.

Clause 14. The cellulosic structure of any preceding clause, wherein the cellulosic board substrate has a lignin content of 14% or more, by weight.

Clause 15. The cellulosic structure of any preceding clause, wherein the cellulosic board substrate has a lignin content of 16% or more, by weight.

Clause 16. The cellulosic structure of any preceding clause, wherein the cellulosic board substrate has a lignin content of 18% or more, by weight.

Clause 17. The cellulosic structure of any preceding clause, wherein the cellulosic board substrate has a basis weight in a range of 180 to 300 pounds per 3000 ft².

Clause 18. The cellulosic structure of any preceding clause, wherein the cellulosic board substrate has a basis weight in a range of 210 to 260 pounds per 3000 ft².

Clause 19. The cellulosic structure of any preceding clause, wherein the cellulosic board substrate has a caliper thickness in a range of 10 to 36 points.

Clause 20. The cellulosic structure of any preceding clause, wherein the cellulosic board substrate has a caliper thickness in a range of 14 to 30 points.

Clause 21. The cellulosic structure of any preceding clause, wherein the cellulosic board substrate has a caliper thickness in a range of 18 to 22 points.

Clause 22. The cellulosic structure of any preceding clause, wherein the oxygen barrier resin layer comprises polyvinyl alcohol (PVOH).

Clause 23. The cellulosic structure of any preceding clause, wherein the oxygen barrier resin layer comprises ethylene vinyl alcohol (EVOH).

Clause 24. The cellulosic structure of any preceding clause, wherein the oxygen barrier resin layer comprises nylon.

Clause 25. The cellulosic structure of any preceding clause, wherein the oxygen barrier resin layer comprises thermoplastic starch.

Clause 26. The cellulosic structure of any preceding clause, wherein the metal oxide coated polymer barrier film comprises at least one of aluminum oxide and silicon oxide.

Clause 27. The cellulosic structure of any preceding clause, wherein the metal oxide coated polymer barrier film comprises at least one of polyester or polyolefin.

Clause 28. The cellulosic structure of any preceding clause, wherein the metal oxide coated polymer barrier film comprises polyethylene terephthalate.

Clause 29. The cellulosic structure of any preceding clause, wherein the outermost heat seal layer comprises low density polyethylene.

Clause 30. The cellulosic structure of any preceding clause, wherein the outermost heat seal layer comprises ethylene methyl acrylate (EMA).

Clause 31. The cellulosic structure of any preceding clause, wherein the oxygen barrier resin layer is between the first side of the cellulosic board substrate and the metal oxide coated polymer barrier film.

Clause 32. The cellulosic structure of any preceding clause, wherein the metal oxide coated polymer barrier film is between the first side of the cellulosic board substrate and the oxygen barrier resin layer.

Clause 33. The cellulosic structure of Clause 32, further comprising a tie layer between the first side of the cellulosic board substrate and the metal oxide coated polymer barrier film.

Clause 34. The cellulosic structure of any preceding clause, wherein the cellulosic structure has a maximum transmittance (% T) in a range of 300-700 nm of 1.0% or less.

Clause 35. The cellulosic structure of any preceding clause, wherein the cellulosic structure has a maximum transmittance (% T) in a range of 300-700 nm of 0.5% or less.

Clause 36. The cellulosic structure of any preceding clause, wherein the cellulosic structure has a maximum transmittance (% T) in a range of 300-700 nm of 0.3% or less.

Clause 37. The cellulosic structure of any preceding clause, wherein the cellulosic structure has a maximum transmittance (% T) in a range of 300-700 nm of 0.2% or less.

Clause 38. The cellulosic structure of any preceding clause, wherein the cellulosic structure has a maximum transmittance (% T) in a range of 300-700 nm of 0.1% or less.

Clause 39. The cellulosic structure of any preceding clause, wherein the cellulosic structure has a maximum transmittance (% T) in a range of 300-700 nm of 0.05% or less.

Clause 40. The cellulosic structure of any preceding clause, wherein the cellulosic structure has at least 80%, by weight, cellulosic content.

Clause 41. The cellulosic structure of any preceding clause, wherein the cellulosic structure has at least 85%, by weight, cellulosic content.

Clause 42. The cellulosic structure of any preceding clause, wherein the cellulosic structure has at least 90%, by weight, cellulosic content.

Clause 43. The cellulosic structure of any preceding clause, wherein the cellulosic structure has an oxygen transmission rate of less than 1 cc/m2/day at 1 atm after folding to 90 degrees.

Clause 44. The cellulosic structure of any preceding clause, wherein the cellulosic structure has an oxygen transmission rate of less than 0.5 cc/m2/day at 1 atm after folding to 90 degrees.

Clause 45. The cellulosic structure of any preceding clause, wherein the cellulosic structure has an oxygen transmission rate of less than 1 cc/m2/day at 1 atm after folding to 180 degrees.

Clause 46. The cellulosic structure of any preceding clause, wherein the cellulosic structure has an oxygen transmission rate of less than 0.5 cc/m2/day at 1 atm after folding to 180 degrees.

Clause 47. The cellulosic structure of any preceding clause, wherein the cellulosic structure has a moisture vapor transmission rate of less than 1 g/m2/day after folding to 90 degrees.

Clause 48. The cellulosic structure of any preceding clause, wherein the cellulosic structure has a moisture vapor transmission rate of less than 0.5 g/m2/day after folding to 90 degrees.

Clause 49. The cellulosic structure of any preceding clause, wherein the cellulosic structure has a moisture vapor transmission rate of less than 1 g/m2/day after folding to 180 degrees.

Clause 50. The cellulosic structure of any preceding clause, wherein the cellulosic structure has a moisture vapor transmission rate of less than 0.5 g/m2/day after folding to 180 degrees.

Clause 51. A cellulosic container, comprising: a sidewall component having a first end and a second end, the sidewall component comprising: a cellulosic board substrate having a first side and a second side; an outermost heat seal layer on the first side of the cellulosic board substrate; an oxygen barrier resin layer between the first side of the cellulosic board substrate and the outermost heat seal layer; and a metal oxide coated polymer barrier film between the first side of the cellulosic board substrate and the outermost heat seal layer; a bottom component enclosing the first end of the sidewall component; and a lid component enclosing the second end of the sidewall component.

Clause 52. The cellulosic container of Clause 51, wherein the cellulosic container maintains a sufficient oxygen barrier despite folding/bending of the substrate.

Clause 53. The cellulosic container of Clause 51 or Clause 52, wherein when the substrate is folded or bent, degradation of the oxygen barrier is inhibited at the folded or bent areas.

Clause 54. The cellulosic container of any one of Clauses 51-53, wherein the integrity of the oxygen barrier is at least maintained at a level sufficient to perform effectively as an oxygen barrier at areas of folding or bending of the substrate.

Clause 55. The cellulosic container of any one of Clauses 51-54, wherein degradation of the oxygen barrier as a result of the formation of cracks or breaks in the oxygen barrier layer of the cellulosic container is inhibited along or adjacent to fold lines used to form the cellulosic container.

Clause 56. The cellulosic container of any one of Clauses 51-55, containing a food item susceptible to light induced degradation.

Clause 57. The cellulosic container of any one of Clauses 51-56, wherein the cellulosic board substrate has a maximum transmittance (% T) in a range of 300-700 nm of 4.0% or less.

Clause 58. The cellulosic container of any one of Clauses 51-56, wherein the cellulosic board substrate has a maximum transmittance (% T) in a range of 300-700 nm of 3.0% or less.

Clause 59. The cellulosic container of any one of Clauses 51-56, wherein the cellulosic board substrate has a maximum transmittance (% T) in a range of 300-700 nm of 2.0% or less.

Clause 60. The cellulosic container of any one of Clauses 51-56, wherein the cellulosic board substrate has a maximum transmittance (% T) in a range of 300-700 nm of 1.0% or less.

Clause 61. The cellulosic container of any one of Clauses 51-56, wherein the cellulosic board substrate has a maximum transmittance (% T) in a range of 300-700 nm of 0.5% or less.

Clause 62. The cellulosic container of any one of Clauses 51-56, wherein the cellulosic board substrate has a maximum transmittance (% T) in a range of 300-700 nm of 0.3% or less.

Clause 63. The cellulosic container of any one of Clauses 51-62, wherein the cellulosic board substrate has a lignin content of 2% or more, by weight.

Clause 64. The cellulosic container of any one of Clauses 51-62, wherein the cellulosic board substrate has a lignin content of 4% or more, by weight.

Clause 65. The cellulosic container of any one of Clauses 51-62, wherein the cellulosic board substrate has a lignin content of 6% or more, by weight.

Clause 66. The cellulosic container of any one of Clauses 51-62, wherein the cellulosic board substrate has a lignin content of 8% or more, by weight.

Clause 67. The cellulosic container of any one of Clauses 51-62, wherein the cellulosic board substrate has a lignin content of 10% or more, by weight.

Clause 68. The cellulosic container of any one of Clauses 51-62, wherein the cellulosic board substrate has a lignin content of 12% or more, by weight.

Clause 69. The cellulosic container of any one of Clauses 51-62, wherein the cellulosic board substrate has a lignin content of 14% or more, by weight.

Clause 70. The cellulosic container of any one of Clauses 51-62, wherein the cellulosic board substrate has a lignin content of 16% or more, by weight.

Clause 71. The cellulosic container of any one of Clauses 51-62, wherein the cellulosic board substrate has a lignin content of 18% or more, by weight.

Clause 72. The cellulosic container of any one of Clauses 51-71, wherein the cellulosic board substrate has a basis weight in a range of 180 to 290 pounds per 3000 ft².

Clause 73. The cellulosic container of any one of Clauses 51-71, wherein the cellulosic board substrate has a basis weight in a range of 210 to 260 pounds per 3000 ft².

Clause 74. The cellulosic container of any one of Clauses 51-73, wherein the cellulosic board substrate has a caliper thickness in a range of 10 to 36 points.

Clause 75. The cellulosic container of any one of Clauses 51-73, wherein the cellulosic board substrate has a caliper thickness in a range of 14 to 30 points.

Clause 76. The cellulosic container of any one of Clauses 51-73, wherein the cellulosic board substrate has a caliper thickness in a range of 18 to 22 points.

Clause 77. The cellulosic container of any one of Clauses 51-76, wherein the oxygen barrier resin layer comprises polyvinyl alcohol (PVOH).

Clause 78. The cellulosic container of any one of Clauses 51-77, wherein the oxygen barrier resin layer comprises ethylene vinyl alcohol (EVOH).

Clause 79. The cellulosic container of any one of Clauses 51-78, wherein the oxygen barrier resin layer comprises nylon.

Clause 80. The cellulosic container of any one of Clauses 51-79, wherein the oxygen barrier resin layer comprises thermoplastic starch.

Clause 81. The cellulosic container of any one of Clauses 51-80, wherein the metal oxide coated polymer barrier film comprises at least one of aluminum oxide and silicon oxide.

Clause 82. The cellulosic container of any one of Clauses 51-81, wherein the metal oxide coated polymer barrier film comprises at least one of polyester or polyolefin.

Clause 83. The cellulosic container of any one of Clauses 51-82, wherein the metal oxide coated polymer barrier film comprises polyethylene terephthalate.

Clause 84. The cellulosic container of any one of Clauses 51-83, wherein the outermost heat seal layer comprises low density polyethylene.

Clause 85. The cellulosic container of any one of Clauses 51-84, wherein the outermost heat seal layer comprises ethylene methyl acrylate (EMA).

Clause 86. The cellulosic container of any one of Clauses 51-85, wherein the oxygen barrier resin layer is between the first side of the cellulosic board substrate and the metal oxide coated polymer barrier film.

Clause 87. The cellulosic container of any one of Clauses 51-86, wherein the metal oxide coated polymer barrier film is between the first side of the cellulosic board substrate and the oxygen barrier resin layer.

Clause 88. The cellulosic container of Clause 87, further comprising a tie layer between the first side of the cellulosic board substrate and the metal oxide coated polymer barrier film.

Clause 89. The cellulosic container of any one of Clauses 51-88, wherein the sidewall component has a maximum transmittance (% T) in a range of 300-700 nm of 1.0% or less.

Clause 90. The cellulosic container of any one of Clauses 51-88, wherein the sidewall component has a maximum transmittance (% T) in a range of 300-700 nm of 0.5% or less.

Clause 91. The cellulosic container of any one of Clauses 51-88, wherein the sidewall component has a maximum transmittance (% T) in a range of 300-700 nm of 0.3% or less.

Clause 92. The cellulosic container of any one of Clauses 51-88, wherein the sidewall component has a maximum transmittance (% T) in a range of 300-700 nm of 0.2% or less.

Clause 93. The cellulosic container of any one of Clauses 51-88, wherein the sidewall component has a maximum transmittance (% T) in a range of 300-700 nm of 0.1% or less.

Clause 94. The cellulosic container of any one of Clauses 51-88, wherein the sidewall component has a maximum transmittance (% T) in a range of 300-700 nm of 0.05% or less.

Clause 95. The cellulosic container of any one of Clauses 51-94, wherein the sidewall component has at least 80%, by weight, cellulosic content.

Clause 96. The cellulosic container of any one of Clauses 51-94, wherein the sidewall component has at least 85%, by weight, cellulosic content.

Clause 97. The cellulosic container of any one of Clauses 51-94, wherein the sidewall component has at least 90%, by weight, cellulosic content.

Clause 98. The cellulosic container of any one of Clauses 51-97, wherein the sidewall component has an oxygen transmission rate of less than 1 cc/m2/day at 1 atm after folding to 90 degrees.

Clause 99. The cellulosic container of any one of Clauses 51-97, wherein the sidewall component has an oxygen transmission rate of less than 0.5 cc/m2/day at 1 atm after folding to 90 degrees.

Clause 100. The cellulosic container of any one of Clauses 51-97, wherein the sidewall component has an oxygen transmission rate of less than 1 cc/m2/day at 1 atm after folding to 180 degrees.

Clause 101. The cellulosic container of any one of Clauses 51-97, wherein the sidewall component has an oxygen transmission rate of less than 0.5 cc/m2/day at 1 atm after folding to 180 degrees.

Clause 102. The cellulosic container of any one of Clauses 51-101, wherein the sidewall component has a moisture vapor transmission rate of less than 1 g/m2/day after folding to 90 degrees.

Clause 103. The cellulosic container of any one of Clauses 51-101, wherein the sidewall component has a moisture vapor transmission rate of less than 0.5 g/m2/day after folding to 90 degrees.

Clause 104. The cellulosic container of any one of Clauses 51-101, wherein the sidewall component has a moisture vapor transmission rate of less than 1 g/m2/day after folding to 180 degrees.

Clause 105. The cellulosic container of any one of Clauses 51-101, wherein the sidewall component has a moisture vapor transmission rate of less than 0.5 g/m2/day after folding to 180 degrees.

Clause 106. A method for manufacturing a cellulosic structure, the method comprising: extruding an oxygen barrier resin layer onto a first side of a cellulosic board substrate; positioning a metal oxide coated polymer barrier film on the extruded oxygen barrier resin layer; and applying a heat seal layer on the metal oxide coated polymer barrier film.

Clause 107. A method for manufacturing a cellulosic structure, the method comprising: coating a liquid adhesive oxygen barrier resin layer onto a first side of a cellulosic board substrate; positioning a metal oxide coated polymer barrier film on the liquid adhesive oxygen barrier resin layer; and applying a heat seal layer on the metal oxide coated polymer barrier film.

Clause 108. A method for manufacturing a cellulosic container, the method comprising: folding the cellulosic structure of any one of Clauses 1-50 to form the cellulosic container.

Clause 109. The method of Clause 108, wherein the cellulosic structure maintains a sufficient oxygen barrier despite folding/bending of the substrate.

Clause 110. The method of Clause 108 or Clause 109, wherein when the substrate is folded or bent, degradation of the oxygen barrier is inhibited at the folded or bent areas.

Clause 111. The method of any one of Clauses 108-110, wherein the integrity of the oxygen barrier is at least maintained at a level sufficient to perform effectively as an oxygen barrier at areas of folding or bending of the substrate.

Clause 112. The method of any one of Clauses 108-111, wherein degradation of the oxygen barrier as a result of the formation of cracks or breaks in the oxygen barrier layer of the cellulosic container is inhibited along or adjacent to fold lines used to form the cellulosic container.

Although various examples of the disclosed cellulosic structures for cellulosic containers and methods for manufacturing thereof have been shown and described, modifications may occur to those skilled in the art upon reading the specification. The present application includes such modifications and is limited only by the scope of the claims.

1. A cellulosic structure, comprising:
a cellulosic board substrate having a first side and a second side;
an outermost heat seal layer on the first side of the cellulosic board substrate;
an oxygen barrier resin layer between the first side of the cellulosic board substrate and the outermost heat seal layer; and
a metal oxide coated polymer barrier film between the first side of the cellulosic board substrate and the outermost heat seal layer.

2. The cellulosic structure of claim 1, wherein the cellulosic board substrate has a maximum transmittance (% T) in a range of 300-700 nm of 4.0% or less.

3. The cellulosic structure of claim 1, wherein the cellulosic board substrate has a basis weight in a range of 180 to 300 pounds per 3000 ft².

4. The cellulosic structure of claim 1, wherein the oxygen barrier resin layer comprises polyvinyl alcohol (PVOH).

5. The cellulosic structure of claim 1, wherein the oxygen barrier resin layer comprises ethylene vinyl alcohol (EVOH).

6. The cellulosic structure of claim 1, wherein the oxygen barrier resin layer comprises at least one of nylon and thermoplastic starch.

7. The cellulosic structure of claim 1, wherein the metal oxide coated polymer barrier film comprises at least one of aluminum oxide and silicon oxide.

8. The cellulosic structure of claim 1, wherein the metal oxide coated polymer barrier film comprises at least one of polyester or polyolefin.

9. The cellulosic structure of claim 1, wherein the outermost heat seal layer comprises at least one of low density polyethylene and ethylene methyl acrylate (EMA).

10. The cellulosic structure of claim 1, wherein the oxygen barrier resin layer is between the first side of the cellulosic board substrate and the metal oxide coated polymer barrier film.

11. The cellulosic structure of claim 1, wherein the metal oxide coated polymer barrier film is between the first side of the cellulosic board substrate and the oxygen barrier resin layer.

12. The cellulosic structure of claim 1, wherein the cellulosic structure has at least 80%, by weight, cellulosic content.

13. The cellulosic structure of claim 1, wherein the cellulosic structure has an oxygen transmission rate of less than 1 cc/m2/day at 1 atm after folding to 90 degrees.

14. The cellulosic structure of claim 1, wherein the cellulosic structure has an oxygen transmission rate of less than 1 cc/m2/day at 1 atm after folding to 180 degrees.

15. The cellulosic structure of claim 1, wherein the cellulosic structure has a moisture vapor transmission rate of less than 1 g/m2/day after folding to 90 degrees.

16. The cellulosic structure of claim 1, wherein the cellulosic structure has a moisture vapor transmission rate of less than 1 g/m2/day after folding to 180 degrees.

17. A method for manufacturing a cellulosic container, the method comprising:
folding the cellulosic structure of claim 1 to form the cellulosic container.

18. A cellulosic container, comprising:
a sidewall component having a first end and a second end, the sidewall component comprising: a cellulosic board substrate having a first side and a second side; an outermost heat seal layer on the first side of the cellulosic board substrate; an oxygen barrier resin layer between the first side of the cellulosic board substrate and the outermost heat seal layer; and a metal oxide coated polymer barrier film between the first side of the cellulosic board substrate and the outermost heat seal layer;
a bottom component enclosing the first end of the sidewall component; and
a lid component enclosing the second end of the sidewall component.

19. A method for manufacturing a cellulosic structure, the method comprising:
performing one of an extruding step and a coating step, wherein the extruding step comprises extruding an oxygen barrier resin layer onto a first side of a cellulosic board substrate, and wherein the coating step comprises coating a liquid adhesive oxygen barrier resin layer onto the first side of the cellulosic board substrate;
positioning a metal oxide coated polymer barrier film on the extruded oxygen barrier resin layer; and
applying a heat seal layer on the metal oxide coated polymer barrier film.

20. (canceled)
